(19) United States
(12) Patent Application Publication
(10) Pub. No.: US 2021/0333158 A1
(43) Pub. Date: Oct. 28, 2021

(54) ELECTRONIC APPARATUS, CONTROL DEVICE, METHOD OF CONTROLLING ELECTRONIC APPARATUS, AND NON-TRANSITORY STORAGE MEDIUM

(71) Applicant: SHARP KABUSHIKI KAISHA, Sakai City (JP)

(72) Inventor: EITAROH AKASHI, Sakai City (JP)

(21) Appl. No.: 17/238,966

(22) Filed: Apr. 23, 2021

(30) Foreign Application Priority Data
Apr. 28, 2020 (JP) 2020-079659

(51) Int. Cl. G01K 11/00; H01Q 1/24; H04B 17/10

(52) U.S. Cl. CPC G01K 11/006; H04B 17/104; H01Q 1/243

(57) ABSTRACT

An electronic apparatus comprises a plurality of antenna modules separated by a distance from each other; a detection unit configured to detect a specific condition of each of the plurality of antenna modules, the specific condition being a factor to degrade that antenna module; and at least one control device, wherein the at least one control device performs activation frequency adjustment in which the at least one control device lowers frequency of activating at least one of the plurality of antenna modules of which the specific condition has been detected by the detection unit to below frequency of activating any of the plurality of antenna modules other than the at least one of the plurality of antenna modules.

### CROSS-REFERENCE TO RELATED APPLICATION

The present application claims priority from Japanese Application JP2020-079659, the content of which is hereby incorporated by reference into this application.

### BACKGROUND

### 1. Field

The disclosure, in an aspect thereof, relates to electronic apparatuses, control devices, methods of controlling an electronic apparatus, and non-transitory storage mediums.

Research has been conducted on methods of retaining the communication capability of an electronic apparatus while the apparatus is in operation. Japanese Unexamined Patent Application Publication, Tokukai, No. 2011-259282 discloses an electronic apparatus including at least two devices that perform the same functions as a device having an internal temperature that rises when used for an extended period of time. The electronic apparatus disclosed in Japanese Unexamined Patent Application Publication, Tokukai, No. 2011-259282 switches between the devices to selectively turn on one of the devices when used for an extended period of time, thereby reducing rises in the internal temperature of the devices without imposing operational or functional restrictions to the user.

### SUMMARY

The technology disclosed in Japanese Unexamined Patent Application Publication, Tokukai, No. 2011-259282 however requires that the electronic apparatus include at least two devices that perform the same functions to lower the temperature of the electronic apparatus. The technology disclosed in Japanese Unexamined Patent Application Publication, Tokukai, No. 2011-259282 therefore requires the two devices to perform the functions that could be technically performed by a single device and for this reason necessitates an extra space. In addition, the electronic apparatus disclosed in Japanese Unexamined Patent Application Publication, Tokukai, No. 2011-259282 includes only one antenna, and no consideration is given to communications by way of use of a plurality of antennas.

The disclosure, in an aspect thereof, has an object to retain the performance of antenna modules and the ensuing communication capability of an electronic apparatus over an extended period of time by way of use of a plurality of antenna modules.

To address the issues, the disclosure, in an aspect thereof, is directed to an electronic apparatus including: a plurality of antenna modules separated by a distance from each other; a detection unit configured to detect a specific condition of each of the plurality of antenna modules, the specific condition being a factor to degrade that antenna module; and at least one control device, wherein the at least one control device performs activation frequency adjustment in which the at least one control device lowers frequency of activating at least one of the plurality of antenna modules of which the specific condition has been detected by the detection unit to below frequency of activating any of the plurality of antenna modules other than the at least one of the plurality of antenna modules.

The disclosure, in another aspect thereof, is directed to a control device that controls an electronic apparatus including: a plurality of antenna modules separated by a distance from each other; and a detection unit configured to detect a specific condition of each of the plurality of antenna modules, the specific condition being a factor to degrade that antenna module, the control device including an activation frequency adjustment unit configured to lower frequency of activating at least one of the plurality of antenna modules of which the specific condition has been detected by the detection unit to below frequency of activating any of the plurality of antenna modules other than the at least one of the plurality of antenna modules.

The disclosure, in a further aspect thereof, is directed to a method of controlling an electronic apparatus including: a plurality of antenna modules separated by a distance from each other; and a detection unit configured to detect a specific condition of each of the plurality of antenna modules, the specific condition being a factor to degrade that antenna module, the method including the activation frequency adjustment step of lowering frequency of activating at least one of the plurality of antenna modules of which the specific condition has been detected by the detection unit to below frequency of activating any of the plurality of antenna modules other than the at least one of the plurality of antenna modules.

The disclosure, in an aspect thereof, can retain the performance of antenna modules and the ensuing communication capability of an electronic apparatus over an extended period of time by way of use of a plurality of antenna modules.

### BRIEF DESCRIPTION OF THE DRAWINGS

FIG. 1 is a perspective view of the exterior of an electronic apparatus in accordance with an embodiment of the disclosure.

FIG. 2 is a block diagram of an electrical configuration of the electronic apparatus shown in FIG. 1.

FIG. 3 is a flow chart representing switching between antenna modules, which is a process performed by the electronic apparatus shown in FIG. 1.

### DESCRIPTION OF EMBODIMENTS

### Structure of Electronic Apparatus 1

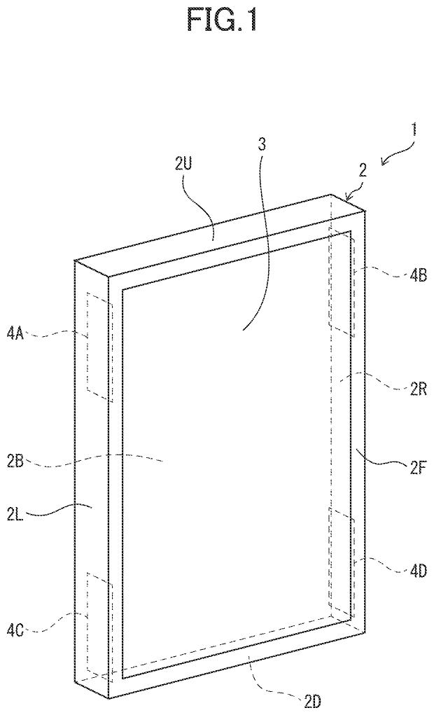

FIG. 1 is a perspective view of the exterior of an electronic apparatus 1 in accordance with an embodiment of the disclosure. The electronic apparatus 1 is, for example, a multifunctional, mobile information processing terminal such as a smartphone or a tablet computer. Referring to FIG. 1, the electronic apparatus 1 includes a housing 2, a display unit 3, a first antenna module 4A, a second antenna module 4B, a third antenna module 4C, and a fourth antenna module 4D. The housing 2 is shaped generally like a rectangular parallelepiped and has a front face 2F, a rear face 2B, a left face 2L, a right face 2R, a top face 2U, and a bottom face 2D.

The display unit 3 is disposed on the front face 2F to display images. The first antenna module 4A is disposed on the left face 2L near the top face 2U. The third antenna module 4C is disposed on the left face 2L near the bottom face 2D. The second antenna module 4B is disposed on the right face 2R near the top face 2U. The fourth antenna module 4D is disposed on the right face 2R near the bottom face 2D.

This particular structure can stabilize communication processes between the electronic apparatus 1 and an external device and also improve communication functions, regarding the first to fourth antenna modules 4A to 4D. The external device is, for example, a communication device installed in a base station.

The first to fourth antenna modules 4A to 4D are disposed inside the housing 2 and separated by a distance from each other. The distance reduces heat transfer between the first to fourth antenna modules 4A to 4D.

The first to fourth antenna modules 4A to 4D are components for wireless or other communications with an external device and each include built-in wireless communications components such as an antenna and a power amplifier. The antenna is preferably a component for accessing a 5G network and more preferably a component for millimeter-wave data communications. The antenna may be a component for accessing a 4G or other data communications network. Since the first to fourth antenna modules 4A to 4D each include a built-in power amplifier, these antenna modules generate heat during communications with the external device.

### Electrical Configuration of Electronic Apparatus 1

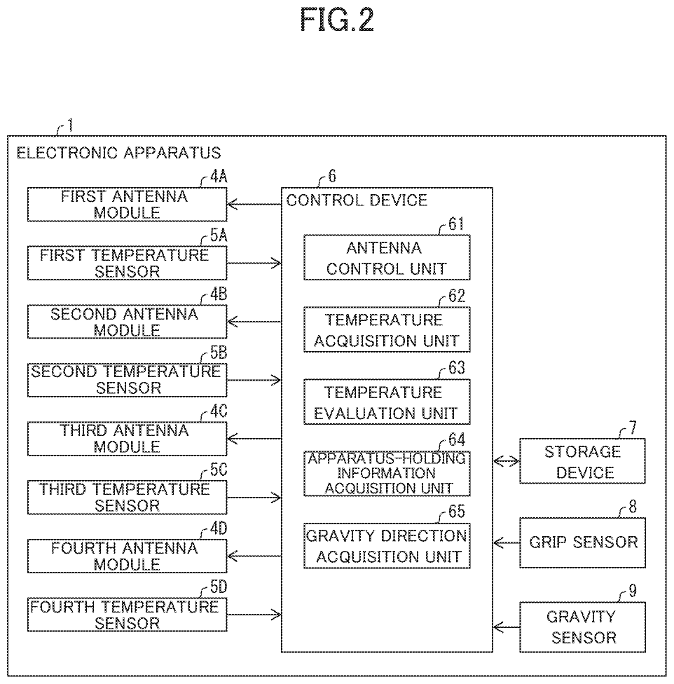

FIG. 2 is a block diagram of an electrical configuration of the electronic apparatus 1 shown in FIG. 1. Referring to FIG. 2, the electronic apparatus 1 includes a first temperature sensor 5A, a second temperature sensor 5B, a third temperature sensor 5C, a fourth temperature sensor 5D, a control device 6, a storage device 7, a grip sensor 8, and a gravity sensor 9.

The first temperature sensor 5A is disposed near the first antenna module 4A to measure the temperature of the first antenna module 4A. Likewise, the second to fourth temperature sensors 5B to 5D are disposed near the second to fourth antennas modules 4B to 4D respectively to measure the temperature thereof.

The first temperature sensor 5A may be disposed inside the first antenna module 4A. In such cases, the first temperature sensor 5A may measure the temperature of the substrate on which the built-in power amplifier of the first antenna module 4A is provided and may measure the temperature of the power amplifier or the temperature of the surroundings thereof. The second to fourth temperature sensors 5B to 5D have a similar structure to the first temperature sensor 5A.

The grip sensor 8 detects a user holding the electronic apparatus 1. The grip sensor 8 is disposed on either one or both of the left face 2L and the right face 2R of the housing 2. The grip sensor 8 is, for example, an electrostatic capacitive sensor or a pressure-sensitive sensor. The grip sensor 8 may be provided singly or as a group of grip sensors 8. The gravity sensor 9 detects the direction of gravity. The gravity sensor 9 is disposed inside the housing 2. The gravity sensor 9 may be provided singly or as a group of gravity sensors 9.

The grip sensor 8 and the gravity sensor 9 function as a detection unit for detecting a specific condition of each of the first to fourth antenna modules 4A to 4D that can be a factor to degrade that antenna module. When the grip sensor 8 functions as the detection unit, the specific condition is a condition where the user is holding the electronic apparatus 1. When the gravity sensor 9 functions as the detection unit, the specific condition is the direction of gravity, and specifically, a condition where any of the first to fourth antenna modules 4A to 4D is located in a vertically lower portion of the electronic apparatus 1.

The control device 6 collectively controls the individual components of the electronic apparatus 1 and includes, for example, a CPU (central processing unit) and a GPU (graphics processing unit). The control device 6 may be provided singly or as a group of control devices 6. The control device 6 includes an antenna control unit 61, a temperature acquisition unit 62, a temperature evaluation unit 63, an apparatus-holding information acquisition unit 64, and a gravity direction acquisition unit 65. The storage device 7 is a flash memory or a like non-volatile memory.

The antenna control unit 61 controls the first to fourth antenna modules 4A to 4D. Specifically, the antenna control unit 61 functions as a transmission electric power adjustment unit for adjusting the transmission electric power of each first to fourth antenna module 4A to 4D. Transmission electric power is the output electric power of each first to fourth antenna module 4A to 4D in transmitting information to an external device in communications with the external device.

The temperature acquisition unit 62 acquires the temperatures of the first to fourth antenna modules 4A to 4D from the first to fourth temperature sensors 5A to 5D respectively. The temperature evaluation unit 63 determines whether or not the temperature of each first to fourth antenna module 4A to 4D acquired by the temperature acquisition unit 62 has reached a prescribed threshold. The antenna control unit 61 selects one of the first to fourth antenna modules 4A to 4D of which the temperature has not reached the prescribed threshold.

The apparatus-holding information acquisition unit 64 acquires, from the grip sensor 8, apparatus-holding information indicating that a user is holding the electronic apparatus 1. The gravity direction acquisition unit 65 acquires gravity information indicating the direction of gravity from the gravity sensor 9.

### Switching Between Antenna Modules

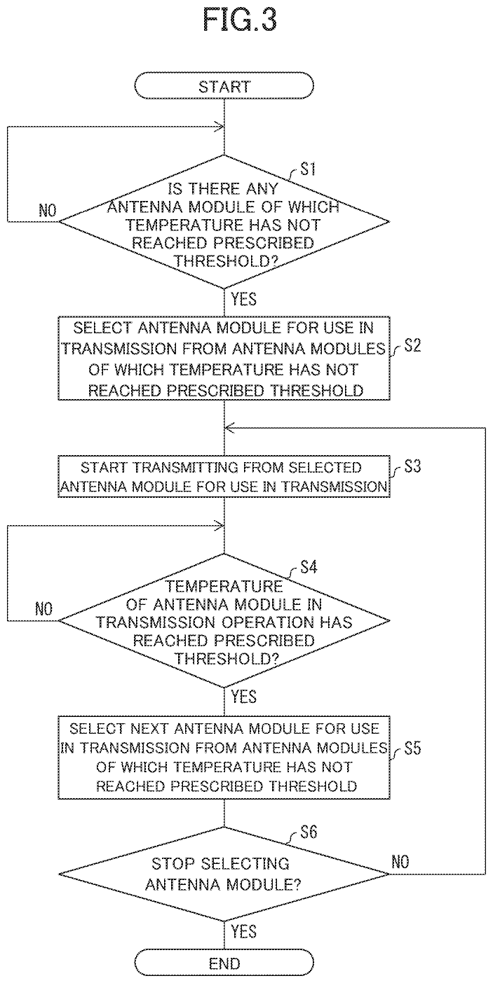

FIG. 3 is a flow chart representing switching between antenna modules, which is a process performed by the electronic apparatus 1 shown in FIG. 1. In this context, it is assumed that the electronic apparatus 1 is on. The temperature acquisition unit 62 provides the antenna control unit 61 with temperature information indicating the acquired temperatures of the first to fourth antenna modules 4A to 4D. The antenna control unit 61 refers to the temperature information provided by the temperature acquisition unit 62.

The antenna control unit 61 determines whether or not there is any of the first to fourth antenna modules 4A to 4D of which the temperature has not reached the prescribed threshold (S1). Upon determining that there is no antenna module of which the temperature has not reached the prescribed threshold (NO in S1), the antenna control unit 61 repeats step S1.

On the other hand, upon determining that there is/are an antenna module(s) of which the temperature has not reached the prescribed threshold (YES in S1), the antenna control unit 61 selects one of the first to fourth antenna modules 4A to 4D of which the temperature has not reached the prescribed threshold as the antenna module for use in transmission (S2). The antenna module selected for use in transmission will be used in transmitting information from the electronic apparatus 1 to an external device. As an example, the antenna control unit 61 selects the first antenna module 4A as the antenna module for use in transmission.

The antenna control unit 61 activates the first antenna module 4A selected as the antenna module for use in transmission. In other words, the antenna control unit 61 increases the transmission electric power of the first antenna module 4A from 0 to a prescribed transmission electric power, thereby starting to transmit information to the external device from the first antenna module 4A selected as the antenna module for use in transmission (S3).

While the antenna control unit 61 is controlling the first antenna module 4A, the temperature acquisition unit 62 acquires from the first temperature sensor 5A the temperature of the first antenna module 4A measured by the first temperature sensor 5A. The temperature acquisition unit 62 provides the temperature evaluation unit 63 with the temperature information indicating the acquired temperature of the first antenna module 4A.

The temperature evaluation unit 63 refers to the temperature information provided by the temperature acquisition unit 62. The temperature evaluation unit 63 determines whether or not the temperature of the first antenna module 4A, which is in the transmission operation, has reached the prescribed threshold (S4). Upon determining that the temperature of the first antenna module 4A, which is in the transmission operation, has not reached the prescribed threshold (NO in S4), the temperature evaluation unit 63 repeats step S4.

On the other hand, upon determining that the temperature of the first antenna module 4A, which is in the transmission operation, has reached the prescribed threshold (YES in S4), the temperature evaluation unit 63 provides the antenna control unit 61 with temperature evaluation information indicating that the temperature of the first antenna module 4A has reached the prescribed threshold. The antenna control unit 61 refers to the temperature evaluation information provided by the temperature evaluation unit 63.

The antenna control unit 61 selects one of the antenna modules of which the temperature has not reached the prescribed threshold as the next antenna module for use in transmission (S5). As an example, the antenna control unit 61 selects the second antenna module 4B as the next antenna module for use in transmission.

In step S5, the antenna control unit 61 activates the second antenna module 4B selected as the antenna module for use in transmission. In other words, the antenna control unit 61 increases the transmission electric power of the second antenna module 4B from 0 to the prescribed transmission electric power, thereby starting to transmit information from the second antenna module 4B to the external device.

The antenna control unit 61 stops the first antenna module 4A simultaneously with carrying out step S5. In other words, the antenna control unit 61 decreases the transmission electric power of the first antenna module 4A from the prescribed transmission electric power to 0. The antenna control unit 61 performs transmission electric power adjustment in this manner in which the transmission electric power of the first antenna module 4A and the transmission electric power of the second antenna module 4B are adjusted.

Alternatively, in step S5, the antenna control unit 61 may select an antenna module of which the transmission electric power is to be increased from the plurality of antenna modules in a prescribed sequence in the transmission electric power adjustment. The prescribed sequence is a sequence in which the first to fourth antenna modules 4A to 4D are activated preferentially over one another and is stored in advance in the storage device 7.

The prescribed sequence may be, as an example, the first antenna module 4A, the second antenna module 4B, the third antenna module 4C, and the fourth antenna module 4D. In such cases, the antenna control unit 61, after activating the first antenna module 4A, selects the second antenna module 4B which comes after the first antenna module 4A in the prescribed sequence, as in step S5.

The antenna control unit 61 thus selects an antenna module of which the transmission electric power is to be increased from the plurality of antenna modules in the prescribed sequence. This particular arrangement provides a simple mechanism to allow for selection of an antenna module of which the transmission electric power is to be increased. The arrangement can hence easily maintain the transmission electric power of the entire electronic apparatus 1.

As another alternative, in step S5, the antenna control unit 61 may select an antenna module of which the transmission electric power is to be increased from the plurality of antenna modules in a random manner in the transmission electric power adjustment. This particular arrangement provides a simple mechanism to allow for selection of an antenna module of which the transmission electric power is to be increased. The arrangement can hence easily maintain the transmission electric power of the entire electronic apparatus 1.

The antenna control unit 61 determines whether or not to stop selecting an antenna module while controlling the second antenna module 4B in step S5 (S6). Upon determining to stop selecting an antenna module (YES in S6), the antenna control unit 61 ends the antenna module switching by the control device 6. Upon determining not to stop selecting an antenna module (NO in S6), the antenna control unit 61 returns the process to step S3.

Whether or not the antenna control unit 61 stops selecting an antenna module in step S6, in other words, whether or not the antenna control unit 61 continues to switch between antenna modules in step S6, may be manually specified by the user on the electronic apparatus 1. When the transmission is to be entirely stopped, for example, when the electronic apparatus 1 has received an instruction from the communication device in the base station to stop the transmission, the antenna control unit 61 simultaneously stops selecting an antenna module.

In other words, when the user has made such settings that the electronic apparatus 1 continues to switch between the antenna modules, the antenna control unit 61 determines in step S6 not to stop selecting an antenna module. On the other hand, when the user has made such settings that the electronic apparatus 1 stops switching between the antenna modules, the antenna control unit 61 determines in step S6 to stop selecting between the antenna modules.

### Selecting Antenna Module

The antenna control unit 61, in step S5, performs activation frequency adjustment in which the antenna control unit 61 lowers the frequency of activating at least one of the plurality of antenna modules of which the specific condition has been detected by the detection unit to below the frequency of activating the other antenna modules. In other words, the antenna control unit 61 functions also as an activation frequency adjustment unit that performs the activation frequency adjustment as detailed in the following.

In the activation frequency adjustment, the antenna control unit 61 lowers the frequency of activating the antenna module located near the point where the grip sensor 8 has detected the user holding the electronic apparatus 1 to below the frequency of activating the other antenna modules.

In this context, it is assumed that the antenna control unit 61 selects antenna modules in a prescribed sequence or in a random manner in step S5. As an example, the second antenna module 4B is located near the point where the grip sensor 8 has detected the user holding the electronic apparatus 1.

In this situation, the antenna control unit 61 selects antenna modules in a prescribed sequence or in a random manner in step S5 so as to lower the frequency of activating the second antenna module 4B to below the frequency of selecting the other antenna modules.

The grip sensor 8 has regions associated respectively with the first to fourth antenna modules 4A to 4D. The region of the grip sensor 8 that is associated with the second antenna module 4B is provided near the second antenna module 4B. As an example, the grip sensor 8 detects the user holding the electronic apparatus 1 in the region thereof that is associated with the second antenna module 4B. In such cases, the apparatus-holding information acquisition unit 64 acquires, as the apparatus-holding information, information indicating that the second antenna module 4B is located near the point where the grip sensor 8 has detected the user holding the electronic apparatus 1.

The apparatus-holding information acquisition unit 64 supplies the acquired apparatus-holding information to the antenna control unit 61. The antenna control unit 61, in step S5, lowers the frequency of selecting the second antenna module 4B to below the frequency of selecting the other antenna modules. In other words, the antenna control unit 61 lowers the frequency of activating the antenna module associated with one of the regions of the grip sensor 8 in which the grip sensor 8 has detected the user holding the electronic apparatus 1 to below the frequency of activating the other antenna modules.

The electronic apparatus 1 will more likely be affected in the communications stability thereof by the degraded performance of the antenna module located near the point where the electronic apparatus 1 is in contact with the hand of the user than by the degraded performance of the other antenna modules. The antenna module located near the point where the grip sensor 8 has detected the user holding the electronic apparatus 1 is therefore preferably less frequently activated. The less frequent activation of such an antenna module can efficiently retain the performance of the antenna modules and the ensuing communication capability of the electronic apparatus 1 over an extended period of time.

In the activation frequency adjustment, the antenna control unit 61 lowers the frequency of activating the antenna module determined to be located in a vertically lower portion of the electronic apparatus 1 on the basis of the direction of gravity detected by the gravity sensor 9 to below the frequency of activating the other antenna modules.

The following description gives more specific details. As an example, the first to fourth antenna modules 4A to 4D each have a specific range of azimuth and a specific range of angle of elevation and depression. The azimuth is an angle with a prescribed direction in a plane that is perpendicular to the direction from the center of the electronic apparatus 1 toward the top face 2U. The angle of elevation and depression is an upward or downward angle with respect to a plane that is perpendicular to the direction from the center of the electronic apparatus 1 toward the top face 2U. The gravity direction acquisition unit 65 determines that the antenna module of which both the range of azimuth and the range of angle of elevation and depression include the direction of gravity is located in the vertically lower portion of the electronic apparatus 1.

The vertically lower portion of the electronic apparatus 1 is more likely to come into contact with the hand of the user than are the other portions of the electronic apparatus 1. The antenna module determined to be located in the vertically lower portion of the electronic apparatus 1 on the basis of the direction of gravity detected by the gravity sensor 9 is therefore preferably less frequently activated. The less frequent activation of such an antenna module can efficiently retain the performance of the antenna modules and the ensuing communication capability of the electronic apparatus 1 over an extended period of time.

The electronic apparatus 1 may include only either one of the grip sensor 8 and the gravity sensor 9. In such cases, the control device 6 includes only either one of the apparatus-holding information acquisition unit 64 and the gravity direction acquisition unit 65.

As described earlier, in step S5, the antenna control unit 61 may select a next antenna module for use in transmission (1) in a prescribed sequence, (2) in a random manner, (3) by using the grip sensor 8, and (4) by using the gravity sensor 9. The antenna control unit 61 may switch between these four methods automatically or in response to a manual specification made by the user on the electronic apparatus 1.

The electronic apparatus 1 thus lowers the frequency of activating the antenna module of which the specific condition has been detected that can be a factor to degrade the antenna module to below the frequency of activating the other antenna modules. This particular arrangement slows down the degradation of the antenna modules and can for this reason retain the performance of the antenna modules and the ensuing communication capability of the electronic apparatus over an extended period of time.

### VARIATION EXAMPLES

The antenna control unit 61 may transmit information from a plurality of antenna modules to the external device. In such cases, the antenna control unit 61 adjusts the transmission electric power of each antenna module in the following manner under the conditions that the sum of the transmission electric power of each antenna module does not exceed a range specified in an industrial standard system.

The antenna control unit 61 may in step S2 select a plurality of antenna modules for use in transmission from the antenna modules of which the temperature has not reached the prescribed threshold. In such cases, the antenna control unit 61, in step S3, starts transmitting information from the plurality of antenna modules selected for use in transmission to the external device.

The temperature evaluation unit 63 may in step S4 determine whether or not the temperature of at least one of the antenna modules that are in the transmission operation has reached the prescribed threshold. If the temperature evaluation unit 63 determines in step S4 that the temperatures of the antenna modules have reached the prescribed threshold, the antenna control unit 61 may in step S5 select a plurality of next antenna modules for use in transmission.

In such cases, the antenna control unit 61, in step S5, activates the plurality of antenna modules selected as the antenna modules for use in transmission. In other words, the antenna control unit 61 increases the transmission electric power of the plurality of antenna modules from 0 to the prescribed transmission electric power. Alternatively, the antenna control unit 61 may increase the transmission electric power of the plurality of antenna modules from a first transmission electric power to a second transmission electric power. The first transmission electric power is non-zero electric power lower than the second transmission electric power.

Additionally, the antenna control unit 61 stops the plurality of antenna modules of which the temperatures are determined in step S4 to have reached the prescribed threshold. In other words, the antenna control unit 61 decreases the transmission electric power of the plurality of antenna modules from the prescribed transmission electric power to 0. Alternatively, the antenna control unit 61 may decrease the transmission electric power of the plurality of antenna modules from the second transmission electric power to the first transmission electric power.

The antenna control unit 61 thus performs the transmission electric power adjustment as follows. Specifically, the antenna control unit 61 decreases the transmission electric power of at least one of the plurality of antenna modules in accordance with the temperatures of the plurality of antenna modules measured by the respective temperature sensors. The antenna control unit 61 also increases the transmission electric power of at least one of the plurality of antenna modules other than the antenna module of which the transmission electric power is to be decreased.

In this particular arrangement, when the temperature of one of the antenna modules rises, the temperature sensor measures the temperature rises, and the transmission electric power of that antenna module is decreased. The arrangement can hence prevent overheating of the entire electronic apparatus 1. Additionally, since the transmission electric power of each antenna module except for the antenna module of which the transmission electric power is decreased is increased, the arrangement can maintain the transmission electric power of the entire electronic apparatus 1.

Additionally, the electronic apparatus 1 performs switching between the plurality of antenna modules that is provided to improve the communication function of the electronic apparatus 1, thereby preventing overheating of the entire electronic apparatus 1. The arrangement therefore requires no additional structure, hence no additional space, in the electronic apparatus 1 to prevent overheating of the entire electronic apparatus 1. The arrangement can also prevent overheating of the entire electronic apparatus 1 without having to make any changes to the structure of the plurality of antenna modules. The plurality of antenna modules can therefore successfully improve the communication function of the electronic apparatus 1.

### Software Implementation

The control blocks of the control device 6 (particularly, the antenna control unit 61, the temperature acquisition unit 62, the temperature evaluation unit 63, the apparatus-holding information acquisition unit 64, and the gravity direction acquisition unit 65) may be implemented by logic circuits (hardware) fabricated, for example, in the form of an integrated circuit (IC chip) and may be implemented by software.

In the latter form of implementation, the control device 6 includes a computer that executes instructions from programs or software by which various functions are provided. This computer includes among others at least one processor (control device) and at least one storage medium containing the programs in a computer-readable format. The processor in the computer then retrieves and runs the programs contained in the storage medium, thereby achieving the object of an aspect of the disclosure. The processor may be, for example, a CPU. The storage medium may be a “non-transitory, tangible medium” such as a ROM (read-only memory), a tape, a disc/disk, a card, a semiconductor memory, or programmable logic circuitry. The control device 6 may further include, for example, a RAM (random access memory) for loading the programs. The programs may be supplied to the computer via any transmission medium (e.g., over a communications network or by broadcasting waves) that can transmit the programs. The disclosure, in an aspect thereof, encompasses data signals on a carrier wave that are generated during electronic transmission of the programs.

### GENERAL DESCRIPTION

The disclosure, in aspect 1 thereof, is directed to an electronic apparatus including: a plurality of antenna modules separated by a distance from each other; a detection unit configured to detect a specific condition of each of the plurality of antenna modules, the specific condition being a factor to degrade that antenna module; and at least one control device, wherein the at least one control device performs activation frequency adjustment in which the at least one control device lowers frequency of activating at least one of the plurality of antenna modules of which the specific condition has been detected by the detection unit to below frequency of activating any of the plurality of antenna modules other than the at least one of the plurality of antenna modules.

In aspect 2 of the disclosure, the electronic apparatus of aspect 1 may be configured such that the detection unit is at least one grip sensor configured to detect, as the specific condition, a user holding the electronic apparatus, and in the activation frequency adjustment, the at least one control device lowers frequency of activating any of the plurality of antenna modules located near a point where the at least one grip sensor has detected a user holding the electronic apparatus to below frequency of activating any of the plurality of antenna modules other than that antenna module.

In aspect 3 of the disclosure, the electronic apparatus of aspect 1 may be configured such that the detection unit is at least one gravity sensor configured to detect a direction of gravity as the specific condition, and in the activation frequency adjustment, the at least one control device lowers frequency of activating any of the plurality of antenna modules determined to be located in a vertically lower portion of the electronic apparatus based on the direction of gravity detected by the at least one gravity sensor to below frequency of activating any of the plurality of antenna modules other than that antenna module.

The disclosure, in aspect 4 thereof, is directed to a control device that controls an electronic apparatus including: a plurality of antenna modules separated by a distance from each other; and a detection unit configured to detect a specific condition of each of the plurality of antenna modules, the specific condition being a factor to degrade that antenna module, the control device including an activation frequency adjustment unit configured to lower frequency of activating at least one of the plurality of antenna modules of which the specific condition has been detected by the detection unit to below frequency of activating any of the plurality of antenna modules other than the at least one of the plurality of antenna modules.

The disclosure, in aspect 5 thereof, is directed to a method of controlling an electronic apparatus including: a plurality of antenna modules separated by a distance from each other; and a detection unit configured to detect a specific condition of each of the plurality of antenna modules, the specific condition being a factor to degrade that antenna module, the method including the activation frequency adjustment step of lowering frequency of activating at least one of the plurality of antenna modules of which the specific condition has been detected by the detection unit to below frequency of activating any of the plurality of antenna modules other than the at least one of the plurality of antenna modules.

The electronic apparatus of any aspect of the disclosure may be implemented on a computer, in which case the computer is controlled so as to serve as various units (software elements) of the electronic apparatus. The disclosure, in an aspect thereof, hence encompasses an electronic apparatus control program causing the computer to implement the electronic apparatus and also encompasses a computer-readable storage medium containing the electronic apparatus control program.

The disclosure is not limited to the description of the embodiments above and may be altered within the scope of the claims. Embodiments based on a proper combination of technical means disclosed in different embodiments are encompassed in the technical scope of the disclosure. Furthermore, new technological features can be created by combining different technical means disclosed in the embodiments.

While there have been described what are at present considered to be certain embodiments of the disclosure, it will be understood that various modifications may be made thereto, and it is intended that the appended claims cover all such modifications as fall within the true spirit and scope of the disclosure.

What is claimed is:

1. An electronic apparatus comprising:
a plurality of antenna modules separated by a distance from each other;
a detection unit configured to detect a specific condition of each of the plurality of antenna modules, the specific condition being a factor to degrade that antenna module; and
at least one control device, wherein
the at least one control device performs activation frequency adjustment in which the at least one control device lowers frequency of activating at least one of the plurality of antenna modules of which the specific condition has been detected by the detection unit to below frequency of activating any of the plurality of antenna modules other than the at least one of the plurality of antenna modules.

2. The electronic apparatus according to claim 1, wherein
the detection unit is at least one grip sensor configured to detect, as the specific condition, a user holding the electronic apparatus, and
in the activation frequency adjustment, the at least one control device lowers frequency of activating any of the plurality of antenna modules located near a point where the at least one grip sensor has detected a user holding the electronic apparatus to below frequency of activating any of the plurality of antenna modules other than that antenna module.

3. The electronic apparatus according to claim 1, wherein
the detection unit is at least one gravity sensor configured to detect a direction of gravity as the specific condition, and
in the activation frequency adjustment, the at least one control device lowers frequency of activating any of the plurality of antenna modules determined to be located in a vertically lower portion of the electronic apparatus based on the direction of gravity detected by the at least one gravity sensor to below frequency of activating any of the plurality of antenna modules other than that antenna module.

4. A control device that controls an electronic apparatus including: a plurality of antenna modules separated by a distance from each other; and a detection unit configured to detect a specific condition of each of the plurality of antenna modules, the specific condition being a factor to degrade that antenna module,
the control device comprising an activation frequency adjustment unit configured to lower frequency of activating at least one of the plurality of antenna modules of which the specific condition has been detected by the detection unit to below frequency of activating any of the plurality of antenna modules other than the at least one of the plurality of antenna modules.

5. A method of controlling an electronic apparatus including: a plurality of antenna modules separated by a distance from each other; and a detection unit configured to detect a specific condition of each of the plurality of antenna modules, the specific condition being a factor to degrade that antenna module,
the method comprising the activation frequency adjustment step of lowering frequency of activating at least one of the plurality of antenna modules of which the specific condition has been detected by the detection unit to below frequency of activating any of the plurality of antenna modules other than the at least one of the plurality of antenna modules.

6. A computer-readable, non-transitory storage medium containing a program causing a computer to function as the electronic apparatus according to claim 1, the program causing the computer to perform the activation frequency adjustment.
